(19) United States
(12) Patent Application Publication
(10) Pub. No.: US 2022/0226185 A1
(43) Pub. Date: Jul. 21, 2022

(54) APPARATUS FOR ACUPRESSURE BASED SELF-MASSAGE

(71) Applicant: Sumeet Ramdass, Murfreesboro, TN (US)

(72) Inventor: Sumeet Ramdass, Murfreesboro, TN (US)

(21) Appl. No.: 17/573,624

(22) Filed: Jan. 11, 2022

Related U.S. Application Data
(60) Provisional application No. 63/138,353, filed on Jan. 15, 2021.

(51) Int. Cl. A61H 15/00; A61H 39/04

(52) U.S. Cl. CPC A61H 15/00; A61H 39/04; A61H 2015/0064; A61H 2201/0157; A61H 2205/081; A61H 2201/1604; A61H 2201/0192; A61H 2203/0456; A61H 2201/1253

(57) ABSTRACT

An apparatus for self-massage of the vertebra includes a board and a frame. The board can be mounted onto the frame and the frame can be placed on ground. The board have several spherical balls protruding outwards from the top surface of the board and the spherical balls can freely rotate. A user can lie down on the board and push himself back and forth on the board wherein the spherical balls rub against the vertebra of the user.

### CROSS-REFERENCE TO RELATED APPLICATIONS

This application claims priority from the U.S. provisional patent application Ser. No. 63/138,353, filed on Jan. 15, 2021, which is incorporated herein by reference in its entirety.

### FIELD OF INVENTION

The present invention relates to an apparatus for self-massage, and more particularly, the present invention relates to an acupressure based portable apparatus for self-massage of the vertebra.

### BACKGROUND

Self-massage devices are well known in the art and different types of self-massage devices are available to self-massage different body parts. For example, foot massagers, back massagers, palm massagers, neck and shoulder massagers, leg massagers, and the like. The self-massage devices are used by athletes, patients, and common people for relieving bodily pains and tension. Athletes often use self-massage devices to speed-up recovery by loosening the stiff muscles. Self-massage devices are also popular among people for relaxation, relieving bodily pains, stimulating blood flow, and many other health benefits.

The self-massage devices for vertebra are limited. Rollers in the shape of wheels are available which the user places against their back and lie back on the roller. By bending and straightening the legs, the user can rollover the wheel for massaging the spine. However, such wheels have several drawbacks including being difficult to use and in particular by overweight people and patients. People find it difficult to stabilize themselves over the wheel that can result in injury. Thus, a need is appreciated for a self-massage device that is easy to use and effective for self-massage of the vertebra or spine.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to an apparatus for self-massage.

It is another object of the present invention that the apparatus is portable.

It is still another object of the present invention that the apparatus can be used to massage the spine by athletes, obese, slender, and the like people.

It is yet another object of the present invention that the apparatus is economical to manufacture.

It is a further object of the present invention that the apparatus is stable on a floor while using.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a perspective view of a board of the disclosed apparatus for self-massage of spine, according to an exemplary embodiment of the present invention.

FIG. 2 is a side view of the acupressure massage board, according to an exemplary embodiment of the present invention.

FIG. 3 shows a frame of the disclosed apparatus, according to an exemplary embodiment of the present invention.

FIG. 4 shows is an enlarged cross-sectional view of the massage board showing the assembly of spherical balls in the massage board, according to an exemplary embodiment of the present invention

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

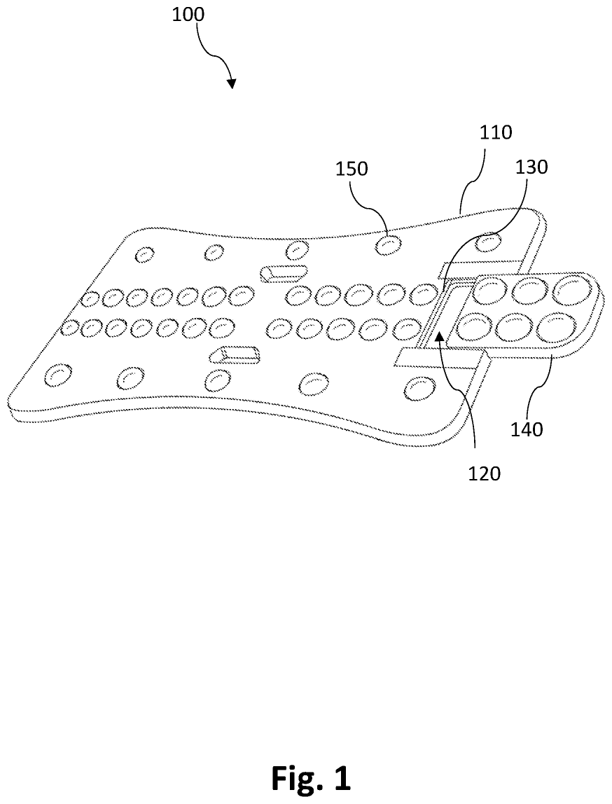

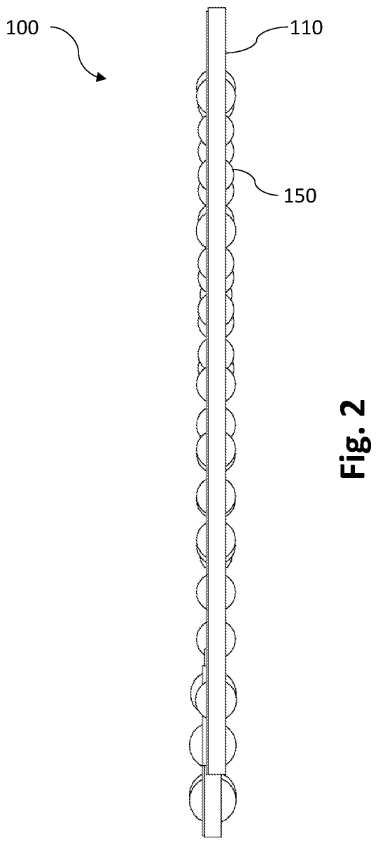

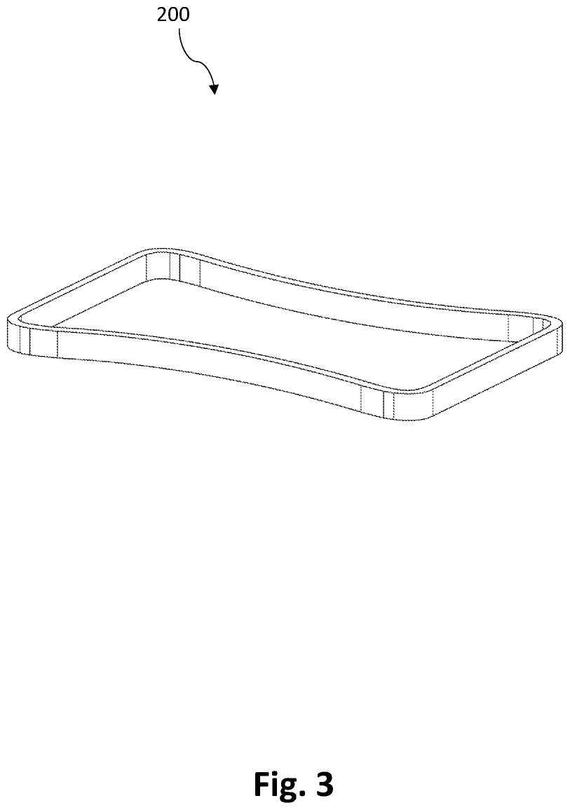

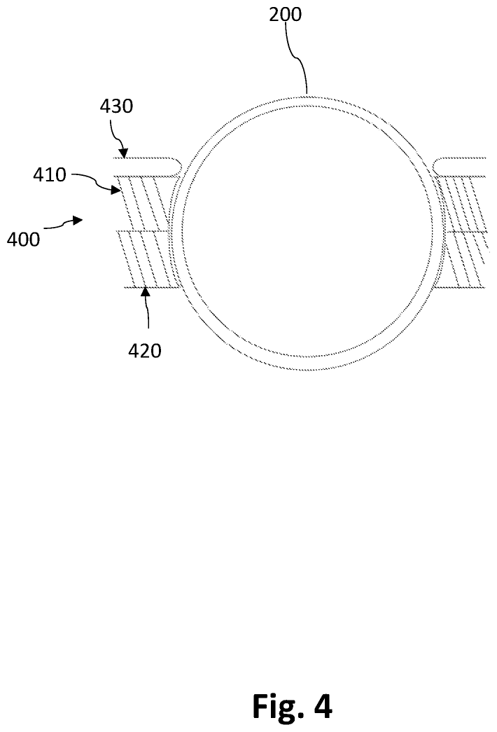

Referring to FIGS. 1-4, which show an exemplary embodiment of the disclosed apparatus for self-massage of different areas of the body, and specifically, the spine, FIG. 1 shows a board 100, FIG. 2 shows another view of the board 100, FIG. 3 shows a frame 200 of the apparatus, and FIG. 4 shows an enlarged cross-sectional view of the board 100. The disclosed apparatus can include the board 100 and the mounting frame 200, wherein the board 100 can mount onto the mounting frame 200. The board 100 can include an elongated platform 110 that can be of a planar geometry and made from a rigid and durable material. For example, sturdy plastic can be used in the manufacture of the elongated platform 110 so that the elongated platform can be light in weight. The elongated platform can have a proximal end and a distal end along a length of the elongated platform 110. At a middle of the proximal end can be a square to rectangular shape cutout 120 in the elongated platform and a channel 130 along a periphery of the cutout 120. The channel can be integral with the elongated platform to form a unitary structure. Alternatively, the channel 130 can also be bonded to the periphery of the cutout 120. A headrest 140 can also be seen in FIG. 1 that is shown slidably mounted to the elongated platform 110 such that the headrest 140 can slide in and out of the channel 130. A user can lie down on the board 100 having his spine rest against a top surface of the board 100. The user can rest his head upon the headrest 140, wherein the headrest 140 can be moved in and out to comfortably accommodate to the position of the head of the user. A length of the headrest can be varied without departing from the scope of the present invention. The board 100 can be of a length such that it runs from head to hip of an adult of a standard height.

The board 100 can further include several spherical balls 150 rotatably mounted in the elongated platform 110, wherein opposite portions of each of the spherical balls can protrude outwards from a top surface and a bottom surface of the elongated platform 110. FIG. 2 which is a side view of the board 100 shows the two opposite portions of the spherical balls 150 protruding from the top and bottom surfaces of the elongated platform 110. The spherical balls 150 can rotate 360 degrees relative to the elongated platform 110. FIG. 4 shows one example of how the spherical balls can be mounted in the elongated platform 110. FIG. 4 shows the elongated platform 400 having two layers i.e., a top layer 410 and a bottom layer 420. The two layers can overlay one over another and bonded together. Both the layers have several apertures for the several spherical balls. Each aperture has a concave shape periphery to retain the spherical ball. The spherical balls can be put in the apertures of the bottom layer 420 and thereafter the top layer can be placed upon the bottom layer such that the portions of the spherical balls protrude outwards from the apertures in the top layer. Once the two layers are in contact with each other and middle portions of the spherical balls are sandwiched between the top layer and the bottom layer, the two layers can be bonded to form the elongated platform 110. A top cushion layer 430 can also be provided. In FIG. 1, the spherical balls can be seen arranged in two parallel rows that extend between the proximal end and the distal end of the elongated platform 110. The positioning of the spherical balls 150 in the elongated platform 110 can be based on the anatomy of the vertebra such that the vertebra can be massaged as described below.

The board 100 can be mounted in a mounting frame 200, such that the spherical balls of the acupressure massage board do not touch the ground when the disclosed apparatus is placed on the ground. The frame 200 can be placed on the ground and the board 100 can be mounted onto the frame 200. The frame 200 can include suitable traction pads (not shown) on the bottom to prevent slipping on the ground. The frame 200 can raise the board 100 off the ground about 2-3 inches so that the spherical balls no longer touch the ground.

In use, a user can first lay down the frame 200 on the ground. Then the board 100 can be put on top of the frame. Once the board 100 is mounted on the frame 200, a user can lie down on his back on the board. The frame remains stationary on the ground due to the traction pads. Now the user can keep his legs grounded at one spot on the ground and supported by the legs, the user can gently push and pull his body back and forth on the board. The protruding spherical balls can rub gently against the spine of the user on multiple areas while the user pushes his body back and forth on the board.

If the user wants to experience a back massage in a non-linear pattern (not back and forth moving motion), they can simply take the board off the frame and can directly lay down the board on the ground. Now the spherical balls will be in direct contact with the ground. Since the spherical balls have 360° of freedom in every direction, the user moves both the back and forth and side to side.

What is claimed is:

1. An apparatus for self-massage of parts of a human body, the apparatus comprising:
a board comprising:
an elongated platform, the elongated platform has a proximal end and a distal end, a plurality of apertures in the elongated platform, the plurality of apertures arranged in one or more rows that extends along a length of the elongated platform between the proximal end and the distal end; and
a plurality of spherical balls rotatably mounted in the plurality of apertures wherein a top portion of each of the plurality of spherical balls protrude above a top surface of the elongated platform and a bottom portion of each of the plurality of spherical balls protrude above a bottom surface of the elongated platform.

2. The apparatus according to claim 1, wherein the elongated platform has a cutout at mid of the proximal end of the elongated platform, a channel coupled along a periphery of the cutout, wherein the apparatus further comprises a headrest slidably mounted to the channel.

3. The apparatus according to claim 2, wherein the headrest is of a rectangular shape that can be pulled outwards from the cutout to increase an overall length of the elongated platform and can be pushed into the cutout to decrease an overall length of the elongated platform, wherein the overall length of the elongated platform is equal to more than a length of the elongated platform.

4. The apparatus according to claim 3, wherein the length and a width of the elongated platform are proportional to a length and a width respectively of a torso of a user of the apparatus.

5. The apparatus according to claim 1, wherein the apparatus further comprises a frame configured to receive the board, wherein the frame is configured to be mounted on ground and the board mounted onto the frame.

6. The apparatus according to claim 5, wherein a height of the frame is such that when the board is mounted on to the frame, the bottom portion of the each of the plurality of spherical balls do not touch the ground on which the frame is mounted.

7. The apparatus according to claim 1, wherein the one or more rows comprises at least two rows that run parallel to each other and spaced apart from each other.
